(19) United States
(12) Patent Application Publication
(10) Pub. No.: US 2019/0382658 A1
(43) Pub. Date: Dec. 19, 2019

(54) QUANTUM DOT COMPOSITIONS AND QUANTUM DOT ARTICLES

(71) Applicant: 3M INNOVATIVE PROPERTIES COMPANY, St. Paul, MN (US)

(72) Inventors: Eric W. NELSON, Stillwater, MN (US); Joseph M. PIEPER, Atlanta, GA (US); Zai-Ming QIU, Woodbury, MN (US); James A. THIELEN, Hugo, MN (US)

(21) Appl. No.: 16/086,668

(22) PCT Filed: Mar. 24, 2017
(86) PCT No.: PCT/US2017/023950

§ 371 Date: Sep. 20, 2018

Related U.S. Application Data
(60) Provisional application No. 62/312,832, filed on Mar. 24, 2016.

(51) Int. Cl. C09K 11/88; C09K 11/02; C09K 15/08; C09K 15/14; C08L 63/00; C08K 5/3492; C08K 5/134; C08K 3/013

(52) U.S. Cl. CPC C09K 11/883; C09K 11/02; C09K 15/08; C09K 15/14; G02F 1/1336; C08K 5/34924; C08K 5/134; C08K 3/013; C08L 63/00

(57) ABSTRACT

Quantum dot compositions comprise quantum dots dispersed in a curable resin composition comprising hindered phenolic antioxidant, wherein the antioxidant comprises about 0.2 wt % to about 5 wt %, based on the total weight of the quantum dot composition.

### FIELD

This invention relates to quantum dot compositions, quantum dot articles and devices comprising quantum dot articles.

### BACKGROUND

Liquid crystal display (LCD) panel constructions comprising blue light emitting diodes (LEDs) and downconversion film elements using a combination of green and red quantum dots as the fluorescing elements have recently generated great interest because they can significantly improve the LCD panel's color gamut. Quantum dots, however, are highly sensitive to moisture and oxygen. Quantum dots are therefore typically dispersed in a low moisture and oxygen permeation resin or polymer material and this material is then sandwiched between two barrier films. Nevertheless, lifetimes of quantum dot downconversion films can be less than desired, particularly under high blue flux conditions.

### SUMMARY

In view of the foregoing, we recognize that there is a need in the art for quantum dot films with improved lifetimes.

Briefly, in one aspect the present invention provides quantum dot compositions comprising quantum dots dispersed in a curable resin composition comprising hindered phenolic antioxidant, wherein the antioxidant comprises about 0.2 wt % to about 5 wt %, based on the total weight of the quantum dot composition.

In another aspect, the present invention provides quantum dot articles comprising (a) a first barrier layer (b) a second barrier layer, and (c) a quantum dot layer between the first barrier layer and the second barrier layer, the quantum dot layer comprising quantum dots dispersed in a matrix comprising a cured curable resin composition, wherein the curable resin composition comprises hindered phenolic antioxidant, wherein the antioxidant comprises about 0.2 wt % to about 5 wt %, based on the total weight of the quantum dot composition.

In yet another aspect, the present invention provides a quantum dot article comprising (a) a first barrier layer, (b) a second barrier layer, and (c) a quantum dot layer between the first barrier layer and the second barrier layer, the quantum dot layer comprising quantum dots dispersed in a matrix comprising a cured curable resin composition that when illuminated by a single pass of 7,000 mW/cm² of 450 nm blue light at 50° C. can maintain a converted power or quantum efficiency greater than 85% its initial value for longer than 80 hours. In some embodiments, the curable resin composition comprises about 0.2 wt % to about 5 wt % hindered phenolic antioxidant, based on the total weight of the quantum dot composition.

In still another aspect, the present invention provides a quantum dot article comprising (a) a first barrier layer, (b) a second barrier layer, and (c) a quantum dot layer between the first barrier layer and the second barrier layer, the quantum dot layer comprising quantum dots dispersed in a matrix comprising a cured curable resin composition comprising hindered phenolic antioxidant; wherein when illuminated by a single pass of 7,000 mW/cm² of 450 nm blue light at 50° C., the quantum dot article can maintain a converted power or quantum efficiency greater than 85% its initial value for at least 1.5 times longer than the same quantum dot article but containing no hindered phenolic antioxidant. In some embodiments, the curable resin comprises about 0.2 wt % to about 0.5 wt %, based on the total weight of the quantum dot composition.

### BRIEF DESCRIPTION OF THE DRAWINGS

FIG. 1 is a schematic illustration of a system used for optical measurements in the Examples.

### DETAILED DESCRIPTION

The present disclosure provides quantum dot compositions comprising quantum dots dispersed in a curable resin composition comprising hindered phenolic antioxidant. Preferred resin compositions provide a matrix with low oxygen and moisture permeability, exhibit high photo- and chemical stability, exhibit favorable refractive indices and adhere to the barrier or other layers adjacent the quantum dot layer. Preferred matrix materials are curable with UV and/or thermal curing methods or combined methods.

Suitable materials for the matrix include, but are not limited to, epoxies, acrylates, norborene, polyethylene, poly(vinyl butyral), poly(vinyl acetate), polyuria, polyurethanes, silicones and silicone derivatives including, but not limited to, amino silicone (AMS), polyphenylsiloxane, polydialkylsiloxane, silsesquioxane, fluorinated silicones and vinyl and hydride substituted silicones; acrylic polymers and copolymers formed from monomers including, but not limited to, methyl methacrylate, butyl methacrylate, and lauryl methacrylate; styrene-based polymers such as polystyrene, amino polystyrene (APS) and poly(acrylonitrile ethylene styrene) (AES); polymers that are crosslinked with difunctional monomers such as divinylbenzene; cross-linkers suitable for crosslinking ligand materials, epoxides which combine with ligand amines to form epoxy, and the like.

Particularly useful curable resin compositions include acrylates, methacrylates, thiol-alkenes, thiol-alkene-epoxies, thiol-epoxies, epoxy-amines and (meth)acrylate-epoxy amines as described, for example, in pending applications 62/148,212, 62/232,071, 62/296,131, 62/148,209, 62/195,434, WO 2015/095,296 and WO 2016/003,986.

Preferably, the curable resin composition comprises a hybrid UV-curable (meth)acrylate and thermal curable epoxy-amine composition or a UV-curable thiol-ene composition.

The curable resin compositions include a hindered phenolic antioxidant. Sterically hindered phenols deactivate free radicals formed during oxidation of the quantum dots or matrix materials. Useful hindered phenolic antioxidants include, for example:

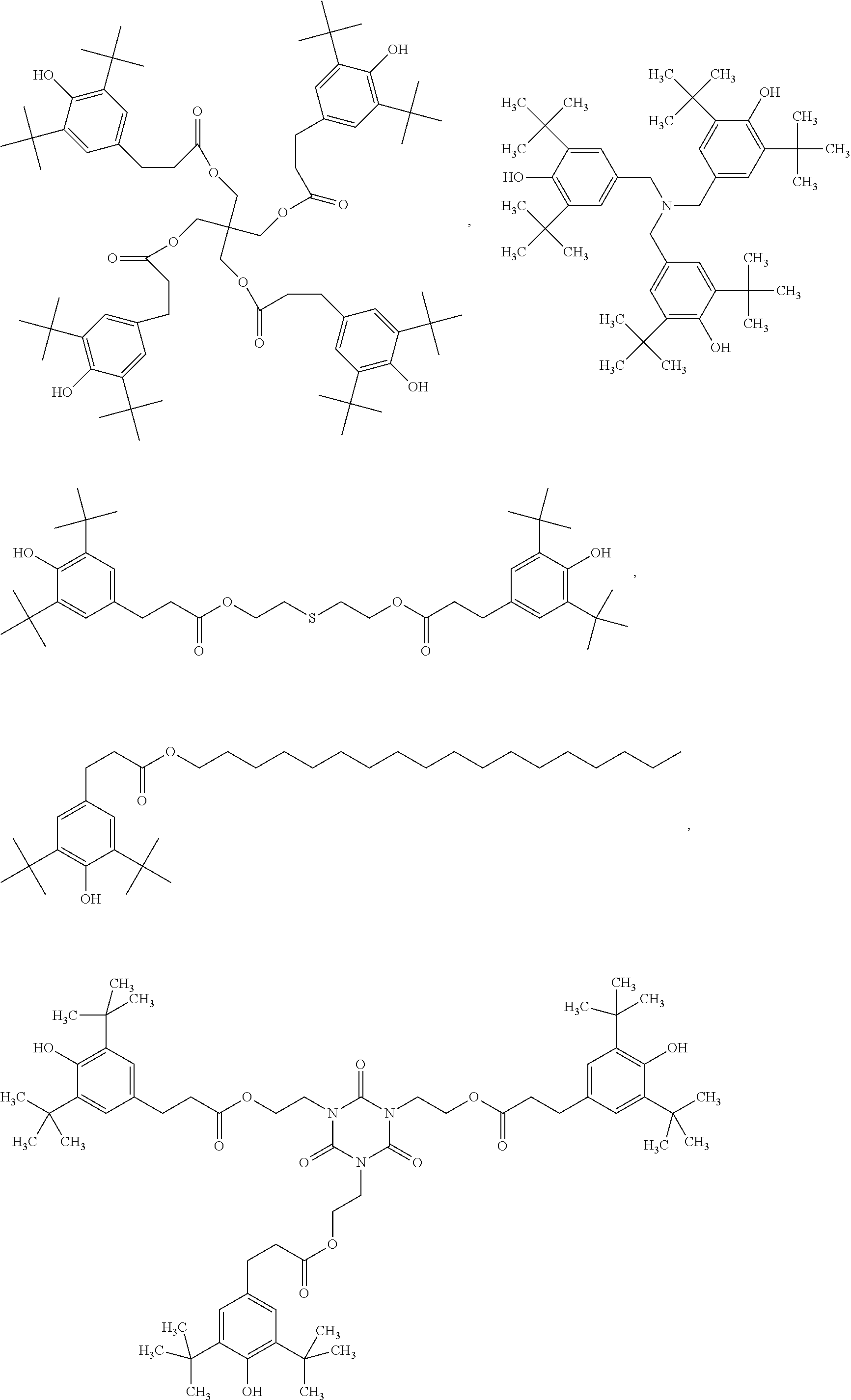

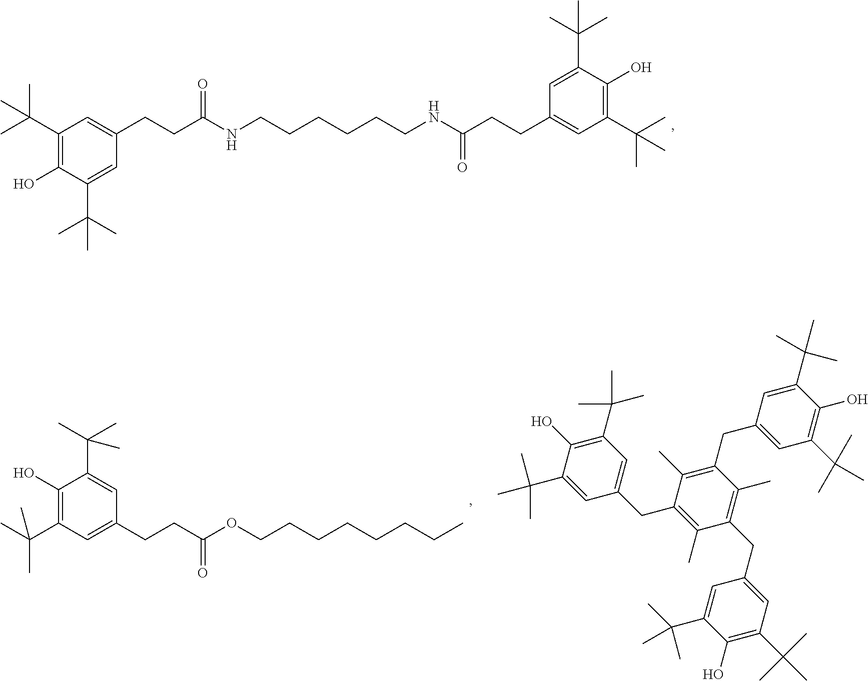

and

Hindered phenolic antioxidants are available from BASF under the trade name IRGANOX. Useful commercially available hindered phenolic antioxidants include IRGANOX 1010, IRGANOX 1035, IRGANOX 1076. IRGANOX 1098, IRGANOX 1135, IRGANOX 1330 and IRGANOX 3114.

Hindered phenolic antioxidants may also comprise curable reactive functional group which can be crosslinked with and locked in matrix or ligand in the cured articles.

For matrixes containing UV-curable resin, the radical curable functional group attached on the hindered phenolic antioxidant may include, for example, enes selected acrylates, (meth)acrylates alkenes, alkynes or thiols. Representative examples of hindered phenolic antioxidants with UV-curable groups include:

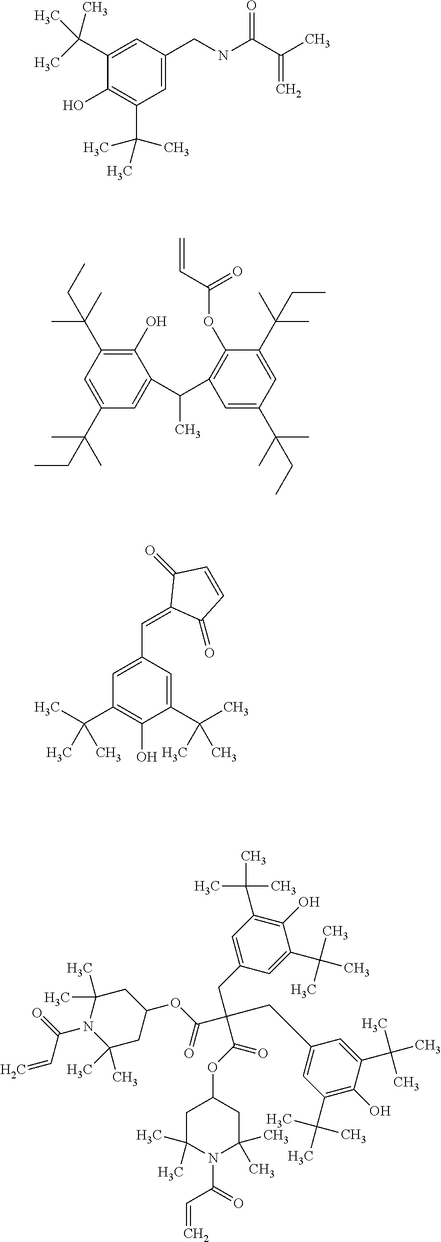

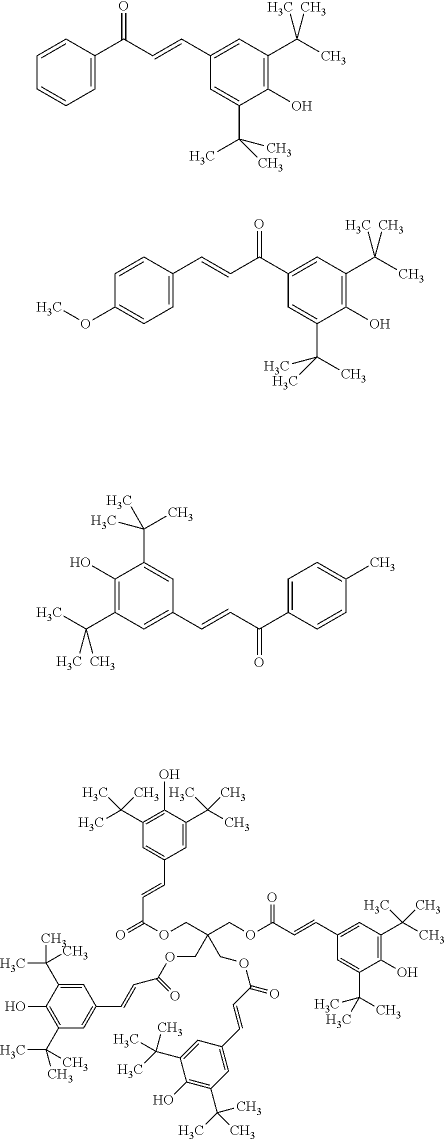

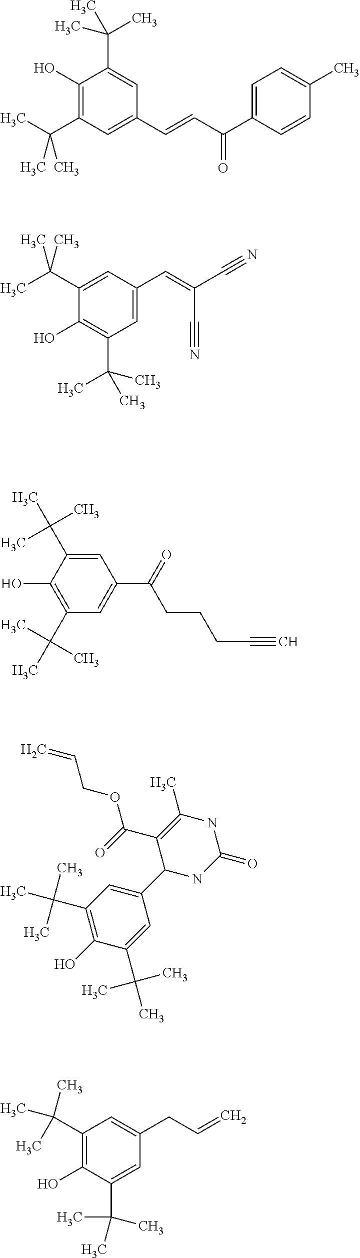

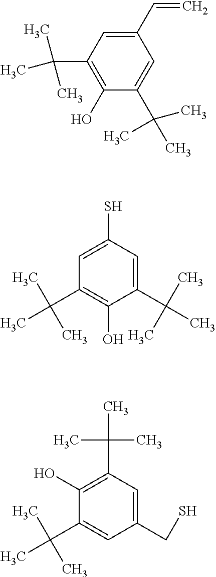

Hindered phenolic antioxidants with acrylate group are available from BASF under the trade name IRGANOX 3052FF and from MAYZO under the trade name BNX 549 and BNX 3052.

For matrixes containing thermal-curable resin, such as epoxy-amine, the thermal curable functional group attached on the hindered phenolic antioxidant may include, for example, epoxy-reactive amine and thiol groups or amine reactive acrylate, methacrylate, aldehyde, ketone and isothiolcyanate groups. Representative examples include:

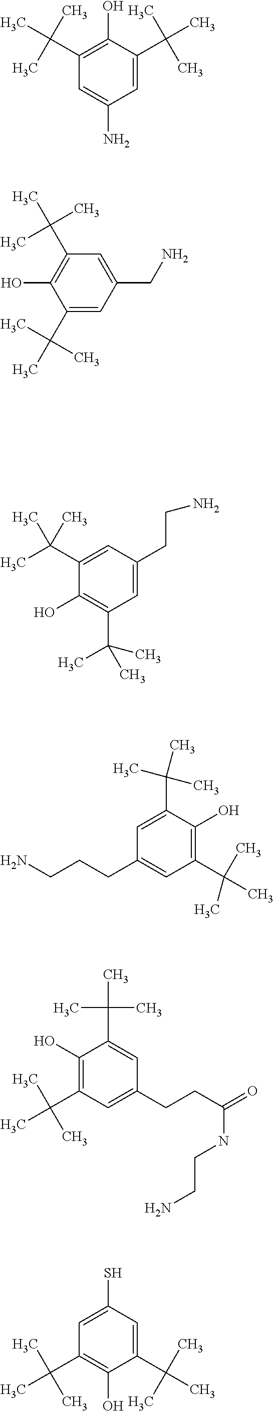

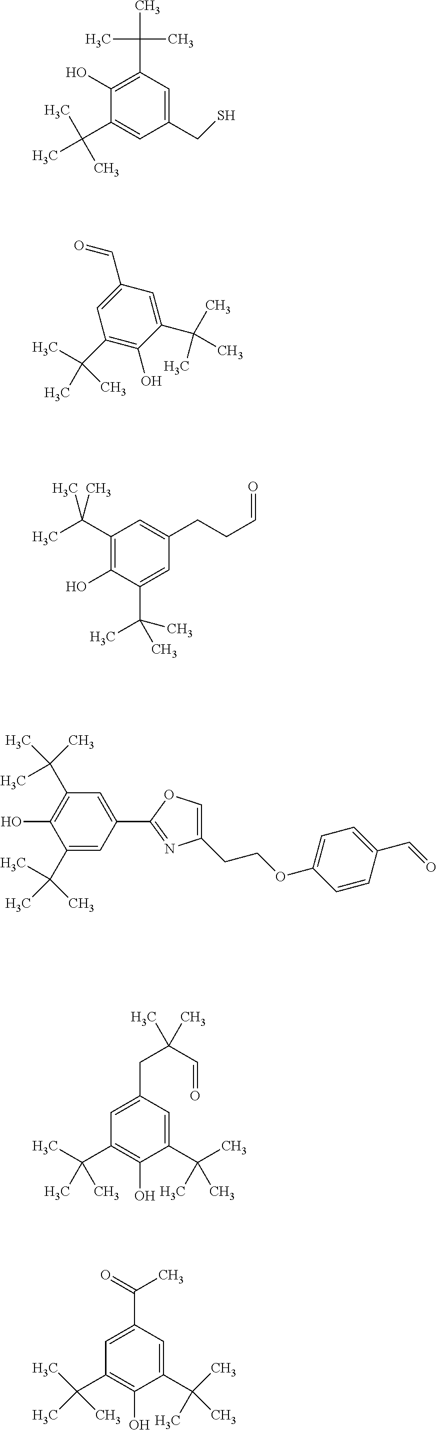 [SMILES: CC(C)(C)c1cc(CS)cc(C(C)(C)C)c1O ; CC(C)(C)c1cc(C=O)cc(C(C)(C)C)c1O ; CC(C)(C)c1cc(CCC=O)cc(C(C)(C)C)c1O ; CC(C)(C)c1cc(-c2nc(CCOc3ccc(C=O)cc3)co2)cc(C(C)(C)C)c1O ; CC(C)(C=O)Cc1cc(C(C)(C)C)c(O)c(C(C)(C)C)c1 ; CC(=O)c1cc(C(C)(C)C)c(O)c(C(C)(C)C)c1]

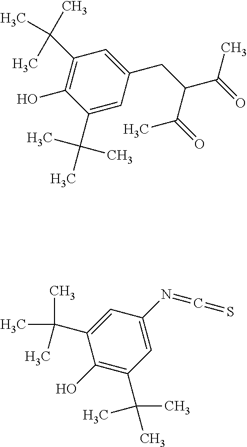 [SMILES: CC(=O)C(Cc1cc(C(C)(C)C)c(O)c(C(C)(C)C)c1)C(C)=O ; CC(C)(C)c1cc(N=C=S)cc(C(C)(C)C)c1O]

The antioxidant typically comprises about 0.2 wt %, about 0.5 wt % or about 1 wt % to about 1.5 wt %, about 2 wt % or about 5 wt %, based on the total weight of the quantum dot composition. In some embodiments, the antioxidant comprises about 0.5 wt % to about 1.5 wt %.

The quantum dots of the present disclosure include a core and a shell at least partially surrounding the core. The core/shell nanoparticles can have two distinct layers, a semiconductor or metallic core and a shell surrounding the core of an insulating or semiconductor material. The core often contains a first semiconductor material and the shell often contains a second semiconductor material that is different than the first semiconductor material. For example, a first Group 12-16 (e.g., CdSe) semiconductor material can be present in the core and a second Group 12-16 (e.g., ZnS) semiconductor material can be present in the shell.

In certain embodiments of the present disclosure, the core includes a metal phosphide (e.g., indium phosphide (InP), gallium phosphide (GaP), aluminum phosphide (AlP)), a metal selenide (e.g., cadmium selenide (CdSe), zinc selenide (ZnSe), magnesium selenide (MgSe)), or a metal telluride (e.g., cadmium telluride (CdTe), zinc telluride (ZnTe)). In certain preferred embodiments of the present disclosure, the core includes a metal selenide (e.g., cadmium selenide).

The shell can be a single layer or multilayered. In some embodiments, the shell is a multilayered shell. The shell can include any of the core materials described herein. In certain embodiments, the shell material can be a semiconductor material having a higher bandgap energy than the semiconductor core. In other embodiments, suitable shell materials can have good conduction and valence band offset with respect to the semiconductor core, and in some embodiments, the conduction band can be higher and the valence band can be lower than those of the core. For example, in certain embodiments, semiconductor cores that emit energy in the visible region such as, for example, CdS, CdSe, CdTe, ZnSe, ZnTe, GaP, InP, or GaAs, or near IR region such as, for example, InP, InAs, InSb, PbS, or PbSe may be coated with a shell material having a bandgap energy in the ultraviolet regions such as, for example, ZnS, GaN, and magnesium chalcogenides such as MgS, MgSe, and MgTe. In other embodiments, semiconductor cores that emit in the near IR region can be coated with a material having a bandgap energy in the visible region such as CdS or ZnSe.

Formation of the core/shell nanoparticles may be carried out by a variety of methods. Suitable core and shell precursors useful for preparing semiconductor cores are known in the art and can include Group 2 elements, Group 12 elements, Group 13 elements, Group 14 elements, Group 15 elements, Group 16 elements, and salt forms thereof. For example, a first precursor may include metal salt (M+X−) including a metal atom (M+) such as, for example, Zn, Cd, Hg, Mg, Ca, Sr, Ba, Ga, In, Al, Pb, Ge, Si, or in salts and a counter ion (X−), or organometallic species such as, for example, dialkyl metal complexes. The preparation of a coated semiconductor nanocrystal core and core/shell nanocrystals can be found in, for example, Dabbousi et al. (1997) J. Phys. Chem. B 101:9463, Hines et al. (1996) J. Phys. Chem. 100: 468-471, and Peng et al. (1997) J. Amer. Chem. Soc. 119:7019-7029, as well as in U.S. Pat. No. 8,283,412 (Liu et al.) and International Publication No. WO 2010/039897 (Tulsky et al.).

In certain preferred embodiments of the present disclosure, the shell includes a metal sulfide (e.g., zinc sulfide or cadmium sulfide). In certain embodiments, the shell includes a zinc-containing compound (e.g., zinc sulfide or zinc selenide). In certain embodiments, a multilayered shell includes an inner shell overcoating the core, wherein the inner shell includes zinc selenide and zinc sulfide. In certain embodiments, a multilayered shell includes an outer shell overcoating the inner shell, wherein the outer shell includes zinc sulfide.

In some embodiments, the core of the shell/core nanoparticle contains a metal phosphide such as indium phosphide, gallium phosphide, or aluminum phosphide. The shell contains zinc sulfide, zinc selenide, or a combination thereof. In some more particular embodiments, the core contains indium phosphide and the shell is multilayered with the inner shell containing both zinc selenide and zinc sulfide and the outer shell containing zinc sulfide.

The thickness of the shell(s) may vary among embodiments and can affect fluorescence wavelength, quantum yield, fluorescence stability, and other photostability characteristics of the nanocrystal. The skilled artisan can select the appropriate thickness to achieve desired properties and may modify the method of making the core/shell nanoparticles to achieve the appropriate thickness of the shell(s).

The diameter of the quantum dots of the present disclosure can affect the fluorescence wavelength. The diameter of the quantum dot is often directly related to the fluorescence wavelength. For example, cadmium selenide quantum dots having an average particle diameter of about 2 to 3 nanometers tend to fluoresce in the blue or green regions of the visible spectrum while cadmium selenide quantum dots having an average particle diameter of about 8 to 10 nanometers tend to fluoresce in the red region of the visible spectrum.

The quantum dots may be surface modified with ligands of Formula VI:

R¹⁵-R¹²(X)ₙ VI
wherein
R¹⁵ is (hetero)hydrocarbyl group having 2 to 30 carbon atoms;
R¹² is a hydrocarbyl group including alkylene, arylene, alkarylene and aralkylene;
n is at least one;
X is a ligand group, including —SH, —CO₂H, —SO₃H, —P(O)(OH)₂, —OP(O)(OH), —OH and —NH₂.

Such additional surface modifying ligands may be added when the functionalizing with the stabilizing additives of Formula VI, or may be attached to the nanoparticles as result of the synthesis. Such additional surface modifying agents are present in amounts less than or equal to the weight of the instant stabilizing additives, preferably 10 wt. % or less, relative to the amount of the ligands.

Various methods can be used to surface modify the quantum dots with the ligand compounds. In some embodiments, procedures similar to those described in U.S. Pat. No. 7,160,613 (Bawendi et al.) and U.S. Pat. No. 8,283,412 (Liu et al.) can be used to add the surface modifying agent. For example, the ligand compound and the quantum dots can be heated at an elevated temperature (e.g., at least 50° C., at least 60° C., at least 80° C., or at least 90° C.) for an extended period of time (e.g., at least 1 hour, at least 5 hours, at least 10 hours, at least 15 hours, or at least 20 hours).

Since InP may be purified by bonding with dodecylsuccinic acid (DDSA) and lauric acid (LA) first, following by precipitation from ethanol, the precipitated quantum dots may have some of the acid functional ligands attached thereto, prior to dispersing in the fluid carrier. Similarly, CdSe quantum dots may be functionalized with amine-functional ligands as result of their preparation, prior to functionalization with the instant ligands. As a result, the quantum dots may be functionalized with those surface modifying additives or ligands resulting from the original synthesis of the nanoparticles.

If desired, any by-product of the synthesis process or any solvent used in surface-modification process can be removed, for example, by distillation, rotary evaporation, or by precipitation of the nanoparticles and centrifugation of the mixture followed by decanting the liquid and leaving behind the surface-modified nanoparticles. In some embodiments, the surface-modified quantum dots are dried to a powder after surface-modification. In other embodiments, the solvent used for the surface modification is compatible (i.e., miscible) with any carrier fluids used in compositions in which the nanoparticles are included. In these embodiments, at least a portion of the solvent used for the surface-modification reaction can be included in the carrier fluid in which the surface-modified, quantum dots are dispersed.

The quantum dots may be dispersed in a solution that contains (a) an optional carrier fluid and (b) the polymeric binder, a precursor of the polymeric binder, or combinations thereof (i.e. the epoxy-amine resin and the radiation curable resin described herein). The nanoparticles may be dispersed in the polymeric or non-polymeric carrier fluid, which is then dispersed in the polymeric binder, forming droplets of the nanoparticles in the carrier fluid, which in turn are dispersed in the polymeric binder. The carrier fluids are typically selected to be compatible (i.e., miscible) with the stabilizing additive (if any) and surface modifying ligand of the quantum dots.

Suitable carrier fluids include, but are not limited to, aromatic hydrocarbons (e.g., toluene, benzene, or xylene), aliphatic hydrocarbons such as alkanes (e.g., cyclohexane, heptane, hexane, or octane), alcohols (e.g., methanol, ethanol, isopropanol, or butanol), ketones (e.g., acetone, methyl ethyl ketone, methyl isobutyl ketone, or cyclohexanone), aldehydes, amines, amides, esters (e.g., amyl acetate, ethylene carbonate, propylene carbonate, or methoxypropyl acetate), glycols (e.g., ethylene glycol, propylene glycol, butylene glycol, triethylene glycol, diethylene glycol, hexylene glycol, or glycol ethers such as those commercially available from Dow Chemical, Midland, Mich. under the trade designation DOWANOL), ethers (e.g., diethyl ether), dimethyl sulfoxide, tetramethylsulfone, halocarbons (e.g., methylene chloride, chloroform, or hydrofluoroethers), or combinations thereof. Preferred carrier fluids include aromatic hydrocarbons (for e.g., toluene), aliphatic hydrocarbons such as alkanes.

The optional non-polymeric carrier fluids are inert, liquid at 25° C. and have a boiling point ≥100° C., preferably ≥150° C.; and can be one or a mixture of liquid compounds. Higher boiling points are preferred so that the carrier fluids remain when organic solvents used in the preparation are removed.

In some embodiments the carrier fluid is an oligomeric or polymeric carrier fluid. The polymeric carriers provide a medium of intermediate viscosity that is desirable for further processing of the additive in combination with the fluorescent nanoparticle into a thin film. The polymeric carrier is preferably selected to form a homogenous dispersion with the additive combined fluorescent nanoparticle, but preferably incompatible with the curable polymeric binders. The polymeric carriers are liquid at 25° C. and include polysiloxanes, such a polydimethylsiloxane, liquid fluorinated polymers, including perfluoropolyethers, (poly(acrylates), polyethers, such as poly(ethylene glycol), poly(propylene glycol), and poly(butylene glycol). A preferred polymeric polysiloxane is polydimethylsiloxane.

Aminosilicone carrier fluids are preferred for CdSe quantum dots, and can also serve as stabilizing ligands. Useful aminosilicones, and method of making the same, are described in US 2013/0345458 (Freeman et al.), incorporated herein by reference. Useful amine-functional silicones are described in Lubkowsha et al., Aminoalkyl Functionalized Siloxanes, Polimery, 2014 59, pp 763-768, and are available from Gelest Inc., Morrisville, Pa., from Dow Corning under the Xiameter™, including Xiamter OFX-0479, OFX-8040, OFX-8166, OFX-8220, OFX-8417, OFX-8630, OFX-8803, and OFX-8822. Useful amine-functional silicones are also available from Siletech.com under the tradenames Silamine™, and from Momentive.com under the tradenames ASF3830, SF4901, Magnasoft, Magnasoft PlusTSF4709, Baysilone OF-TP3309, RPS-116, XF40-C3029 and TSF4707

Desirably, the liquid carrier is chosen to match the transmissivity of the polymer matrix. To increase the optical path length through the quantum dot layer and improve quantum dot absorption and efficiency, the difference in the refractive indices of the carrier liquid and the polymer matrix is ≥0.05, preferably ≥0.1. In some embodiments the amount of ligand and carrier liquid (ligand functional or non-functional) is ≥60 wt. %, preferably ≥70 wt. %, more preferably ≥80 wt. %, relative to the total including the inorganic nanoparticles.

Quantum dot articles of the invention include a first barrier layer, a second barrier layer, and a quantum dot layer between the first barrier layer and the second barrier layer. The quantum dot layer includes a plurality of quantum dots dispersed in a matrix comprising the cured curable resin composition (described herein).

The quantum dot layer can have any useful amount of quantum dots. In some embodiments, the quantum dots are added to the fluid carrier in amounts such that the optical density is at least 10, optical density defined as the absorbance at 440 nm for a cell with a path length of 1 cm) solution.

The barrier layers can be formed of any useful material that can protect the quantum dots from exposure to environmental contaminates such as, for example, oxygen, water, and water vapor. Suitable barrier layers include, but are not limited to, films of polymers, glass and dielectric materials. In some embodiments, suitable materials for the barrier layers include, for example, polymers such as polyethylene terephthalate (PET); oxides such as silicon oxide, titanium oxide, or aluminum oxide (e.g., SiO₂, Si₂O₃, TiO₂, or Al₂O₃); and suitable combinations thereof.

More particularly, barrier films can be selected from a variety of constructions. Barrier films are typically selected such that they have oxygen and water transmission rates at a specified level as required by the application. In some embodiments, the barrier film has a water vapor transmission rate (WVTR) less than about 0.005 g/m²/day at 38° C., and 100% relative humidity; in some embodiments, less than about 0.0005 g/m²/day at 38° C. and 100% relative humidity; and in some embodiments, less than about 0.00005 g/m²/day at 38° C. and 100% relative humidity. In some embodiments, the flexible barrier film has a WVTR of less than about 0.05, 0.005, 0.0005, or 0.00005 g/m²/day at 50° C. and 100% relative humidity or even less than about 0.005, 0.0005, 0.00005 g/m²/day at 85° C. and 100% relative humidity. In some embodiments, the barrier film has an oxygen transmission rate of less than about 0.005 g/m²/day at 23° C. and 90% relative humidity; in some embodiments, less than about 0.0005 g/m²/day at 23° C. and 90% relative humidity; and in some embodiments, less than about 0.00005 g/m²/day at 23° C. and 90% relative humidity.

Exemplary useful barrier films include inorganic films prepared by atomic layer deposition, thermal evaporation, sputtering, and chemical vapor deposition. Useful barrier films are typically flexible and transparent. In some embodiments, useful barrier films comprise inorganic/organic. Flexible ultra-barrier films comprising inorganic/organic multilayers are described, for example, in U.S. Pat. No. 7,018,713 (Padiyath et al.). Such flexible ultra-barrier films may have a first polymer layer disposed on polymeric film substrate that is overcoated with two or more inorganic barrier layers separated by at least one second polymer layer. In some embodiments, the barrier film comprises one inorganic barrier layer interposed between the first polymer layer disposed on the polymeric film substrate and a second polymer layer.

In some embodiments, each barrier layer of the quantum dot article includes at least two sub-layers of different materials or compositions. In some embodiments, such a multi-layered barrier construction can more effectively reduce or eliminate pinhole defect alignment in the barrier layers, providing a more effective shield against oxygen and moisture penetration into the cured polymeric matrix. The quantum dot article can include any suitable material or combination of barrier materials and any suitable number of barrier layers or sub-layers on either or both sides of the quantum dot layer. The materials, thickness, and number of barrier layers and sub-layers will depend on the particular application, and will suitably be chosen to maximize barrier protection and brightness of the quantum dots while minimizing the thickness of the quantum dot article. In some embodiments each barrier layer is itself a laminate film, such as a dual laminate film, where each barrier film layer is sufficiently thick to eliminate wrinkling in roll-to-roll or laminate manufacturing processes. In one illustrative embodiment, the barrier layers are polyester films (e.g., PET) having an oxide layer on an exposed surface thereof.

The quantum dot layer can include one or more populations of quantum dots or quantum dot materials. Exemplary quantum dots or quantum dot materials emit green light and red light upon down-conversion of blue primary light from a blue LED to secondary light emitted by the quantum dots. The respective portions of red, green, and blue light can be controlled to achieve a desired white point for the white light emitted by a display device incorporating the quantum dot article. Exemplary quantum dots for use in the quantum dot articles included, but are not limited to CdSe with ZnS shells. Suitable quantum dots for use in quantum dot articles described herein include, but are not limited to, core/shell fluorescent nanocrystals including CdSe/ZnS, InP/ZnS, PbSe/PbS, CdSe/CdS, CdTe/CdS or CdTe/ZnS.

In exemplary embodiments, the nanoparticles include a ligand, a fluid carrier and are dispersed in the cured or uncured polymeric binder. Quantum dot and quantum dot materials are commercially available from, for example, Nanosys Inc., Milpitas, Calif.

The quantum dot article can be formed, for example, by coating the curable composition including quantum dots and antioxidant on a first barrier layer and disposing a second barrier layer on the quantum dot material. In some embodiments, the method includes polymerizing (e.g., radiation curing) the radiation curable composition to form a cured matrix. In some embodiments, the method includes polymerizing the radiation curable composition to form a partially cured quantum dot material and polymerizing (e.g., thermal curing) a curing agent of the partially cured quantum dot material to form a cured matrix.

The curable composition can be cured or hardened by applying radiation such as ultraviolet (UV) or visible light to cure the radiation curable component, followed by heating to cure the thermally curable component. In some example embodiments UV cure conditions can include applying about 10 mJ/cm² to about 4000 mJ/cm² of UVA, more preferably about 10mJ/cm² to about 200 mJ/cm² of UVA. Heating and UV light may also be applied alone or in combination to increase the viscosity of the curable composition, which can allow easier handling on coating and processing lines.

In some embodiments, the curable composition may be cured after lamination between the overlying barrier films. Thus, the increase in viscosity of the curable composition locks in the coating quality right after lamination. By curing right after coating or laminating, in some embodiments the cured composition increases the viscosity of the curable composition to a point that the curable composition acts as an adhesive to hold the laminate together during further processing steps. In some embodiments, the radiation cure of the curable composition provides greater control over coating, curing and web handling as compared to traditional thermal curing of an epoxy only curable composition.

Once at least partially cured, the composition forms a polymer network that provides a protective matrix for the quantum dots.

In various embodiments, the thickness of the quantum dot layer 20 is about 40 microns to about 400 microns, or about 80 microns to about 250 microns.

In various embodiments, the color change observed upon aging is defined by a change of less than 0.02 on the 1931 CIE (x,y) Chromaticity coordinate system following an aging period of 1 week at 85° C. In certain embodiments, the color change upon aging is less than 0.005 on the following an aging period of 1 week at 85° C.

The lifetime of the quantum dot film element of the invention upon aging is greatly increased as compared to quantum dot film elements without a hindered phenolic antioxidant. In some embodiments, this lifetime improvement is at least about 1.5× increase, at least about 2× increase, at least about 5× increase, at least about 8× or at least about 10× increase. Surprisingly, other types of common stabilizers such as, for example, phosphite antioxidants, hindered amine light stabilizers, UVA absorbers and 2-hydroxyphenyl-bensophenones do not provide any significant lifetime improvement.

The quantum dot articles of the invention can be used in display devices. Such display devices can include, for example, a backlight with a light source such as, for example, a LED. The light source emits light along an emission axis. The light source (for example, a LED light source) emits light through an input edge into a hollow light recycling cavity having a back reflector thereon. The back reflector can be predominately specular, diffuse or a combination thereof, and is preferably highly reflective. The backlight further includes a quantum dot article, which includes a protective matrix having dispersed therein quantum dots. The protective matrix is bounded on both surfaces by polymeric barrier films, which may include a single layer or multiple layers.

The display device can further include a front reflector that includes multiple directional recycling films or layers, which are optical films with a surface structure that redirects off-axis light in a direction closer to the axis of the display. In some embodiments, the directional recycling films or layers can increase the amount of light propagating on-axis through the display device, this increasing the brightness and contrast of the image seen by a viewer. The front reflector can also include other types of optical films such as polarizers. In one non-limiting example, the front reflector can include one or more prismatic films and/or gain diffusers. The prismatic films may have prisms elongated along an axis, which may be oriented parallel or perpendicular to an emission axis of the light source. In some embodiments, the prism axes of the prismatic films may be crossed. The front reflector may further include one or more polarizing films, which may include multilayer optical polarizing films, diffusely reflecting polarizing films, and the like. The light emitted by the front reflector enters a liquid crystal (LC) panel. Numerous examples of backlighting structures and films may be found in, for example, U.S. Published Application No. US 2011/0051047.

### EXAMPLES

Objects and advantages of this invention are further illustrated by the following examples, but the particular materials and amounts thereof recited in these examples, as well as other conditions and details, should not be construed to unduly limit this invention.

All parts, percentages, ratios, etc. in the examples and the rest of the specification are by weight, unless noted otherwise. Solvents and other reagents used were obtained from Sigma-Aldrich Chemical Company, St. Louis, Mo., unless otherwise noted.

TABLE 1
Materials

| Trade designation | | |
|---|---|---|
| or common name | Material Description | Source (Location) |
| EPON 824 | Bisphenol A backbone epoxy resin | Momentive Specialty Chemicals |
| | | (Columbus, OH) |
| EPIC 91B | Chain extended triethylene glycol diamine curing agent | Epic Resins (Palmyra, WI) |
| QCEF62290R2-01 | Red quantum dot concentrate | Nanosys Corp. (Milpitas, CA) |
| QCEF53040R2-01 | Green quantum dot concentrate | Nanosys Corp. (Milpitas, CA) |
| SR348 | Bisphenol-A dimethacrylate | Sartomer USA, LLC (Exton, PA) |
| DAROCUR 4265 | Photoinitiator | BASF Resins (Wyandotte, MI) |
| Irganox 1010 | Hindered phenolic antioxidant | BASF (Wyandotte, MI) |
| Irganox 1076 | Hindered phenolic antioxidant | BASF (Wyandotte, MI) |
| Irganox 1035 | Hindered phenolic antioxidant | BASF (Wyandotte, MI) |
| Irganox 1130 | Hindered phenolic antioxidant | BASF (Wyandotte, MI) |
| Irganox 1135 | Hindered phenolic antioxidant | BASF (Wyandotte, MI) |
| Irganox 1726 | Multifunctional phenolic antioxidant | BASF (Wyandotte, MI) |
| Irganox 3114 | Hindered phenolic antioxidant | BASF (Wyandotte, MI) |
| Irgafos 126 | Organo-phosphite stabilizer | BASF (Wyandotte, MI) |
| Irgafos 168 | Organo-phosphite stabilizer | BASF (Wyandotte, MI) |
| Tinuvin 123 | Hindered amine light stabilizer | BASF (Wyandotte, MI) |
| TEMPIC | 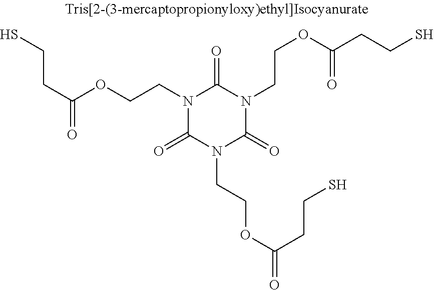 [SMILES: O=C(CCS)OCCn1c(=O)n(CCOC(=O)CCS)c(=O)n(CCOC(=O)CCS)c1=O] | Bruno Bock Chemische Fabrik GmbH & Co. KG (Marschacht, Germany) |
| TAIC | 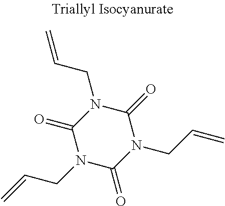 [SMILES: C=CCn1c(=O)n(CC=C)c(=O)n(CC=C)c1=O] | TCI America (Portland, Oregon) |
| LUCIRIN TPO-L | Ethyl-2,4,6-trimethylbenzoylphenylphosphinate | BASF Corporation (Florham |
| | | Park, New Jersey) |

### Optical Measurements

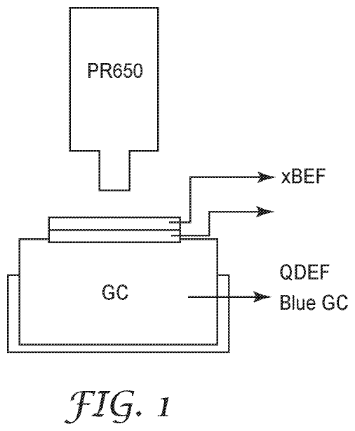

The optical properties of quantum dot enhancement film (QDEF) samples were the white point (color) and luminance (brightness, cd/m²) quantified by placing the constructed QDEF sample into a recycling system (shown in FIG. 1) and measuring its optical properties with a SpectraScan™ PR-650 SpectraColorimeter with an MS-75 lens, available from Photo Research, Inc., Chatsworth, Calif. The QDEF samples were placed on top of a diffusely transmissive hollow light box. The diffuse transmission and reflection of the light box can be described as Lambertian. The light box was a six-sided hollow cube measuring approximately 12.5 cm×12.5 cm×11.5 cm (L×W×H) made from diffuse PTFE plates of about 6 mm thickness.

One face of the box was chosen as the sample surface. The hollow light box had a diffuse reflectance of about 0.83 measured at the sample surface (e.g. about 83%, averaged over the 400-700 nm wavelength range).

The hollow light box was illuminated from within by a blue LED light source (about 450 nm). The sample color and luminance was measured with the PR-650 at normal incidence to the plane of the box sample surface when the sample films were placed parallel to the box sample surface, the sample films being in general contact with the box.

Two micro-replicated brightness enhancement films (available from 3M Corp., St. Paul, Minn., under the trade designation 3M BEF) were placed in a 90 degree crossed configuration above the QDEF. The entire measurement was carried out in a black enclosure to eliminate stray light sources. A white point and luminance value was measured for each film sample in this recycling system.

### Accelerated Aging—

Mini Test Box:

An in-house designed light acceleration box was used for accelerated aging. The light box contained blue LEDs with a peak wavelength of about 450 nm and an output intensity of about 450 mW/cm². The walls and bottom of the light box are lined with a reflective metal material (Anolux Miro-Silver manufactured by Anomet, Ontario, Canada) to provide light recycling. A ground glass diffuser was placed over the LEDs to improve the illumination uniformity (Haze level). An approximately 3×3.5 inch test specimen was placed directly on the glass diffuser. A metal reflector (Anolux Miro-Silver) was then placed over the samples to simulate recycling in a typical LED backlight. The sample temperature was maintained at about 50° C. using air flow and heat sinks. The samples were considered to have failed when the normalized brightness reached 85% of the initial value.

High Intensity Light Testers (HILTS):

The sample chamber in turn is temperature controlled with a forced air method creating constant temperature air flow over the sample surfaces. This system can control the ambient temperature between 45° C. and 100° C. and the incident blue flux up to 300 mW/cm². Although these systems have proven to be very reliable they are limited by their optical design which does not allow recycling thus limiting the amount of flux acceleration they are capable of. In addition, although the forced air approach allowed for a stable temperature to be reached, it could not fully compensate for self-heating in the samples due to absorption of the incident blue flux. This would result in a temperature offset for the sample versus the ambient temperature.

Screening High Intensity Light Testers:

These systems were designed to provide independent flux and temperature control by creating physical separation of the light source and sample chamber. They use a single pass through the sample, the illuminated spot size on the sample produces a flux up to 10,000 mW/cm². In addition, a sapphire window was added to the sample holder to sandwich the sample and offer a direct path to the sample for temperature control. This enabled the control of temperature even with the elevated incident fluxes.

### Formulation and Testing of Matrices Comprising Quantum Dots and Anti-Oxidants Examples 1 and 2: QDEFs Comprising a Hybrid Epoxy Acrylate Resin and Irganox 1076

Examples 1 and 2 were quantum dot enhancement films comprising a cured hybrid epoxy acrylate matrix, quantum dots, and Irganox 1076. The two-part epoxy acrylate formulations were made by combining resin part A (comprising an epoxy-functional monomer, an acrylate monomer, and photoinitiator) with resin part B (comprising a diamine) as described in Table 2. Production quantum dots from Nanosys Inc. were used at a total concentration of 5.867% in Examples 1 and 2 and in a green to red ratio of 2.54:1.

TABLE 2
Components of two-part epoxy acrylate formulation.

| Part A | Part B |
|---|---|
| 80% Epon 824 | EPIC 91B |
| 20% SR348 | |
| 1 part per hundred resin Darocur 4265 | |

TABLE 3
Compositions and optical testing results of Examples 1 and 2.

| | | Example number | | |
|---|---|---|---|---|
| | | (weight percentage in formulation) | | |
| Formulation Components | | Control | 1 | 2 |
| Part A | | 66.85% | 66.60 | 66.6 |
| Part B | | 27.29% | 27.00 | 26.5 |
| Red quantum dot concentrate | | 1.66% | 1.69 | 1.66 |
| Green quantum dot concentrate | | 4.21% | 4.21 | 4.26 |
| Irganox 1076 | | — | 0.50 | 1.50 |
| Initial luminance (cd/m²) | | 274.16 | 281.00 | 280.88 |
| x (CIE 1931) | | 0.2184 | 0.2271 | 0.2302 |
| y (CIE 1931) | | 0.1859 | 0.1865 | 0.1875 |
| Optical Exposure | Failure time | 205 | 695 | 1047 |
| Test Results | (hours) | | | |
| | Lifetime | — | 3.4 | 5.1 |
| | Improvement | | | |
| | (normalized | | | |
| | to Control) | | | |

### Preparation of Resins and QDEFs Comprising the Resins

Under a nitrogen atmosphere, white formulas of quantum dot (QD) concentrate were created by combining appropriate amounts resin part A, resin part B, red and green QDs, and Irganox 1076 in a mixer outfitted with a high shear impeller blade (such as a Cowles blade mixer, available from Cowles Products, North Haven Conn.) at 1400 rpm for 4 minutes. The components were added in the weight proportions shown in Table 3.

These QD-containing resins were coated between two 2 mil (0.05 mm) barrier films (available as FTB3-M-125 from 3M Company, St. Paul Minn.) at a thickness of 100 micrometers using a knife coater, again under a nitrogen atmosphere. The coatings were first cured with ultraviolet (UV) radiation using a Clearstone UV LED lamp (available from Clearstone Technologies, Inc., Hopkins Minn.) at 385 nm for 30 seconds using 50% power under a nitrogen atmosphere, and then thermally cured in an oven at 100° C. for 20 minutes.

Table 3 also shows the initial luminance and x y color for the control and epoxy/acrylate antioxidant samples after they were produced. Very little difference is observed between the control and examples, indicating that the antioxidants are not interfering with the QD performance.

The example films and control films were subjected to accelerated aging testing using the as described above. Table 3 shows the results of the accelerated aging test. As can be seen in Table 3, the control sample failed at 205 hours. The control sample was an average of production QDEF using production QDs and the hybrid matrix. The control sample utilized the same matrix system and QDs, but to provide a greater level of control was produced on the manufacturing equipment.

Examples of the invention comprising Irganox 1076 showed a significantly longer life time under accelerated aging conditions compared to the control. Example 1 did not fail until almost 700 hours of accelerated aging, and Example 2 did not fail until 1047 hours of accelerated aging, representing a greater than 3-fold and 5-fold increase, respectively.

### Examples 3-7: QDEFs Comprising a Hybrid Epoxy Acrylate Resin and Antioxidant

Examples 3-7 were quantum dot enhancement films comprising a cured hybrid epoxy acrylate matrix, quantum dots, and antioxidant material. The two-part epoxy acrylate formulations were made by combining resin part A (comprising an epoxy-functional monomer, an acrylate monomer, and photoinitiator) with resin part B (comprising a diamine) as described in Table 2. Formulations and optical exposure test results are presented in Table 4. A QDEF comprising a hybrid epoxy acrylate matrix that did not contain any added antioxidant was used as a control. Comparative Example 1 was a QDEF that comprised a multifunctional antioxidant (Irganox 1726) and is presented in Table 4 as CE1. Production quantum dots from Nanosys Inc. were used at a total concentration of 7.00% and a green to red ratio of 2.54:1.

Preparation of Hybrid Epoxy Acrylate Resins and QDEFs Comprising them

Under a nitrogen atmosphere, white formulas of quantum dot (QD) concentrate were created by combining appropriate amounts resin part A, resin part B, red and green QDs, and antioxidant in a mixer outfitted with a high shear impeller blade (such as a Cowles blade mixer, available from Cowles Products, North Haven Conn.) at 1400 rpm for 4 minutes. The components were added as shown in Table 4.

These QD-containing resins were coated between two 2 mil (0.05 mm) barrier films (available as FTB3-M-125 from 3M Company, St. Paul Minn.) at a thickness of 100 micrometers using a knife coater, again under a nitrogen atmosphere. The coatings were first cured with ultraviolet (UV) radiation using a Clearstone UV LED lamp (available from Clearstone Technologies, Inc., Hopkins Minn.) at 385 nm for 30 seconds using 50% power under a nitrogen atmosphere, and then thermally cured in an oven at 100° C. for 20 minutes.

The example films and control films were subjected to screening high intensity accelerated aging testing as described above. Table 4 shows the results of the accelerated aging test. As can be seen in Table 4, the control QDEF failed at 21 hours. The control QDEF was a sample prepared in the same procedure utilizing the same quantum dots and the hybrid matrix, but containing no antioxidant. Examples 3-7 showed a significantly longer life time under accelerated aging conditions compared to the control. The lifetime improvement ranged from 1.25-fold to 9.9-fold increase. However, the multifunctional antioxidant Irganox 1726 used in Comparative Example 1 should no improvement compared to the control.

TABLE 4
Compositions of Epoxy-Acrylate Hybrid Matrices.

| | | Example number | | | | | | |
|---|---|---|---|---|---|---|---|---|
| | | (weight percentage in formulation) | | | | | | |
| Formulation Components | | Control | CE1 | 3 | 4 | 5 | 6 | 7 |
| Part A | | 66.04 | 65.42 | 65.42 | 65.42 | 65.42 | 65.54 | 65.29 |
| Part B | | 26.96 | 26.33 | 26.33 | 26.33 | 27.33 | 26.46 | 26.21 |
| Red quantum dot concentrate | | 1.98 | 1.98 | 1.98 | 1.98 | 1.98 | 1.98 | 1.98 |
| Green quantum dot concentrate | | 5.02 | 5.02 | 5.02 | 5.02 | 5.02 | 5.02 | 5.02 |
| Irganox 1076 | | — | — | — | 1.00 | — | — | 1.50 |
| Irganox 1010 | | — | — | 1.00 | — | — | 1.00 | — |
| Irganox 1135 | | — | — | — | — | 1.00 | — | — |
| Irganox 1726 | | — | 1.00 | — | — | — | — | — |
| Irgafos 126 | | — | 0.25 | 0.25 | 0.25 | 0.25 | — | — |
| Optical | Failure time (hours) | 21.2 | 20.8 | 34.9 | 107 | 110 | 26.7 | 209 |
| Exposure Test | Lifetime Improvement | — | 0.98 | 1.6 | 5.1 | 5.2 | 1.25 | 9.9 |
| Results | (normalized to Control) | | | | | | | |

### Example 8: QDEF Comprising a Thiol-Ene Matrix and Irganox 1076

Example 8 was prepared by mixing the polythiol TEMPIC and the polyene TAIC at the desired equivalent ratio shown in Table 5. The TPO-L was combined with the polyene prior to mixing. Then the quantum dot concentrates and Irganox 1076 were added under a nitrogen atmosphere. The samples were mixed together with a high shear impeller blade such as a Cowles blade mixer (available from Cowles Products, North haven CT) at 1400 rpm for 4 minutes.

TABLE 5
Components of a thiol-ene resin formulation comprising quantum dots
and Irganox 1076.
Example 8

| Components | Weight percentage | grams |
|---|---|---|
| TEMPIC (Polythiol) | 61.42% | 15.36 |
| TAIC (Polyene) | 32.21% | 8.05 |
| Red quantum dot concentrate | 1.66% | 0.41 |
| Green quantum dot concentrate | 4.21% | 1.05 |
| Irganox 1076 | 0.50% | 0.13 |
| Total | 100.00% | 25.00 |

The mixed resin containing quantum dots and Irganox 1076 was coated between two 2 mil (0.05 mm) barrier films (available as FTB3-M-125 from 3M Company, St. Paul Minn.) at a thickness of 100 micrometers using a knife coater under a nitrogen atmosphere. The coating was cured with ultraviolet (UV) radiation using a Clearstone UV LED lamp (available from Clearstone Technologies, Inc., Hopkins Minn.) at 385 nm for 30 seconds using 100% power under a nitrogen atmosphere to provide a QDEF comprising a cured thiol-ene matrix, red and green quantum dots, and Irganox 1076.

For each QDEF film specimen, the white point (color) and luminance (brightness) were measured as previously described. Accelerated aging testing was conducted as previously described using the mini test box. The samples were considered failed when the normalized brightness reached 85% of the initial value. Table 6 shows the results of the accelerated aging test.

The control sample for this example was a thiol-ene QDEF specimen that contained no added antioxidant material. As can be seen in Table 6, the control sample failed after 100 hours of accelerated aging. Example 8 containing Irganox 1076 reached 300 hours of accelerated aging before failing, showing a significant lifetime improvement.

TABLE 6
Effect of accelerated aging on Example 8 compared to control QD film

| | | Lifetime Improvement |
|---|---|---|
| Sample Name | 85% Failure Time | (normalized to control) |
| Control | 100 | |
| Example 8 | 300 | 3.0 |

Table 7 shows the initial luminance and x y color for the control QDEF and Example 8 (antioxidant containing) thiol-ene specimens. Very little difference in optical properties was found for the control and Example 3, indicating that the antioxidant did not interfere with the QD performance.

TABLE 7
Initial luminance and x y color of control QDEF and Example 8.

| | Luminance (cd/m²) | x (CIE 1931) | y (CIE 1931) |
|---|---|---|---|
| Control 1 | 274.16 | 0.2184 | 0.1859 |
| Example 8 | 296.68 | 0.2343 | 0.1969 |

### Examples 9-17

Examples 9-17 were quantum dot enhancement films comprising a cured thiol-ene matrix, quantum dots and one or more antioxidant materials. The thiol-ene formulations were made by combining a thiol resin, an alkene resin, and a photo-initiator. Production quantum dots from Nanosys Inc. were used at a total concentration of 4.00% and a green to red ratio of 3.4:1. Under a nitrogen atmosphere, white formulas of quantum dot (QD) concentrate were created by combining appropriate amounts of thiol, alkene, red and green QDs, and antioxidant(s) according to the formulations provided in Table 8 in a mixer outfitted with a high shear impeller blade (such as a Cowles blade mixer, available from Cowles Products, North Haven Conn.) at 1400 rpm for 4 minutes.

These QD-containing resins were coated between two 2 mil (0.05 mm) barrier films (available as FTB3-M-50 from 3M Company, St. Paul Minn.) at a thickness of 100 micrometers using a knife coater, again under a nitrogen atmosphere. The coatings were first cured with ultraviolet (UV) radiation using a Clearstone UV LED lamp (available from Clearstone Technologies, Inc., Hopkins Minn.) at 385 nm for 15 seconds using 50% power under a nitrogen atmosphere, and then further UV cured in a Fusion UV system with D-Bulb at 60 feet/minute (available from Heraeus Noblelight America LLC, Gaithersburg, Md.).

The example films and control films were subjected to screening high intensity accelerated aging testing as described above. Table 8 shows the results of the accelerated aging test. As can be seen in Table 8, the control QDEF failed at 8 hours. The control QDEF was a sample prepared in the same procedure utilizing the same quantum dots and the thiol-ene matrix, but containing no antioxidant. Examples 9-17 showed a significantly longer life time under accelerated aging conditions compared to the control. The lifetime improvement ranged from 2.5-fold to 6.875-fold increase.

TABLE 8
Additional Thiol-ene Resin Formulations and Optical Exposure Test Results.

| | Control | | Example 9 | | Example 10 | | Example 11 | | Example 12 | | Example 13 | |
|---|---|---|---|---|---|---|---|---|---|---|---|---|
| Formulation Components | wt % | grams | wt % | grams | wt % | grams | wt % | grams | wt % | grams | wt % | grams |
| TEMPIC | 62.16 | 28.04 | 61.64 | 28.03 | 61.59 | 28.06 | 61.61 | 28.05 | 61.60 | 28.06 | 61.00 | 27.75 |
| TAIC | 32.76 | 14.78 | 32.75 | 14.89 | 32.69 | 14.89 | 32.73 | 14.90 | 32.74 | 14.91 | 32.73 | 14.89 |
| TPO-L | 0.98 | 0.44 | 0.98 | 0.45 | 0.98 | 0.45 | 0.98 | 0.45 | 0.98 | 0.45 | 0.98 | 0.45 |
| Red quantum dot concentrate | 0.92 | 0.42 | 0.90 | 0.41 | 0.91 | 0.41 | 0.94 | 0.43 | 0.92 | 0.42 | 0.90 | 0.41 |
| Green quantum dot concentrate | 3.17 | 1.43 | 3.11 | 1.41 | 3.21 | 1.46 | 3.11 | 1.41 | 3.14 | 1.43 | 3.14 | 1.43 |
| Irganox 1076 | — | — | — | — | — | — | — | — | — | — | — | — |
| Irganox 1010 | — | — | — | — | — | — | 0.62 | 0.28 | — | — | — | — |
| Irganox 1035 | — | — | — | — | 0.62 | 0.28 | — | — | — | — | 1.24 | 0.57 |
| Irganox 1135 | — | — | 0.62 | 0.28 | — | — | — | — | — | — | — | — |
| Irganox 1330 | — | — | — | — | — | — | — | — | — | — | — | — |
| Irganox 1726 | — | — | — | — | — | — | — | — | 0.62 | 0.28 | — | — |
| Irganox 3114 | — | — | — | — | — | — | — | — | — | — | — | — |
| Irgafos 126 | — | — | — | — | — | — | — | — | — | — | — | — |
| Irgafos 168 | — | — | — | — | — | — | — | — | — | — | — | — |

| | | | | | | | |
|---|---|---|---|---|---|---|---|
| Optical | Failure time (hours) | 8 | 40 | 22 | 36 | 33 | 32 |
| Exposure | Lifetime | — | 5 | 2.75 | 4.5 | 4.125 | 4 |
| Test | Improvement | | | | | | |
| Results | (normalized to | | | | | | |
| | Control) | | | | | | |

| | Example 14 | | Example 15 | | Example 16 | | Example 17 | |
|---|---|---|---|---|---|---|---|---|
| Formulation Components | wt % | grams | wt % | grams | wt % | grams | wt % | grams |
| TEMPIC | 61.88 | 28.08 | 61.81 | 28.01 | 62.62 | 28.36 | 62.57 | 28.33 |
| TAIC | 32.84 | 14.90 | 32.88 | 14.90 | 32.55 | 14.74 | 32.60 | 14.76 |
| TPO-L | 0.53 | 0.24 | 0.55 | 0.25 | 0.51 | 0.23 | 0.53 | 0.24 |
| Red quantum dot concentrate | 0.89 | 0.40 | 0.88 | 0.40 | 0.89 | 0.41 | 0.88 | 0.40 |
| Green quantum dot concentrate | 3.09 | 1.40 | 3.10 | 1.40 | 3.10 | 1.40 | 3.09 | 1.40 |
| Irganox 1076 | — | — | — | — | — | — | — | — |
| Irganox 1010 | — | — | — | — | — | — | — | — |
| Irganox 1035 | — | — | — | — | — | — | — | — |
| Irganox 1135 | 0.63 | 0.28 | 0.62 | 0.28 | — | — | — | — |
| Irganox 1330 | — | — | — | — | 0.33 | 0.15 | — | — |
| Irganox 1726 | — | — | — | — | — | — | — | — |
| Irganox 3114 | — | — | — | — | — | — | 0.33 | 0.15 |
| Irgafos 126 | 0.16 | 0.07 | — | — | — | — | — | — |
| Irgafos 168 | — | — | 0.16 | 0.07 | — | — | — | — |

| | | | | | |
|---|---|---|---|---|---|
| Optical | Failure time (hours) | 43 | 55 | 20 | 28 |
| Exposure | Lifetime | 5.375 | 6.875 | 2.5 | 3.5 |
| Test | Improvement | | | | |
| Results | (normalized to | | | | |
| | Control) | | | | |

The complete disclosures of the publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A quantum dot composition comprising quantum dots dispersed in a curable resin composition comprising hindered phenolic antioxidant, wherein the antioxidant comprises about 0.2 wt % to about 5 wt %, based on the total weight of the quantum dot composition.

2. The quantum dot composition of claim 1 wherein the antioxidant is selected from the group consisting of:

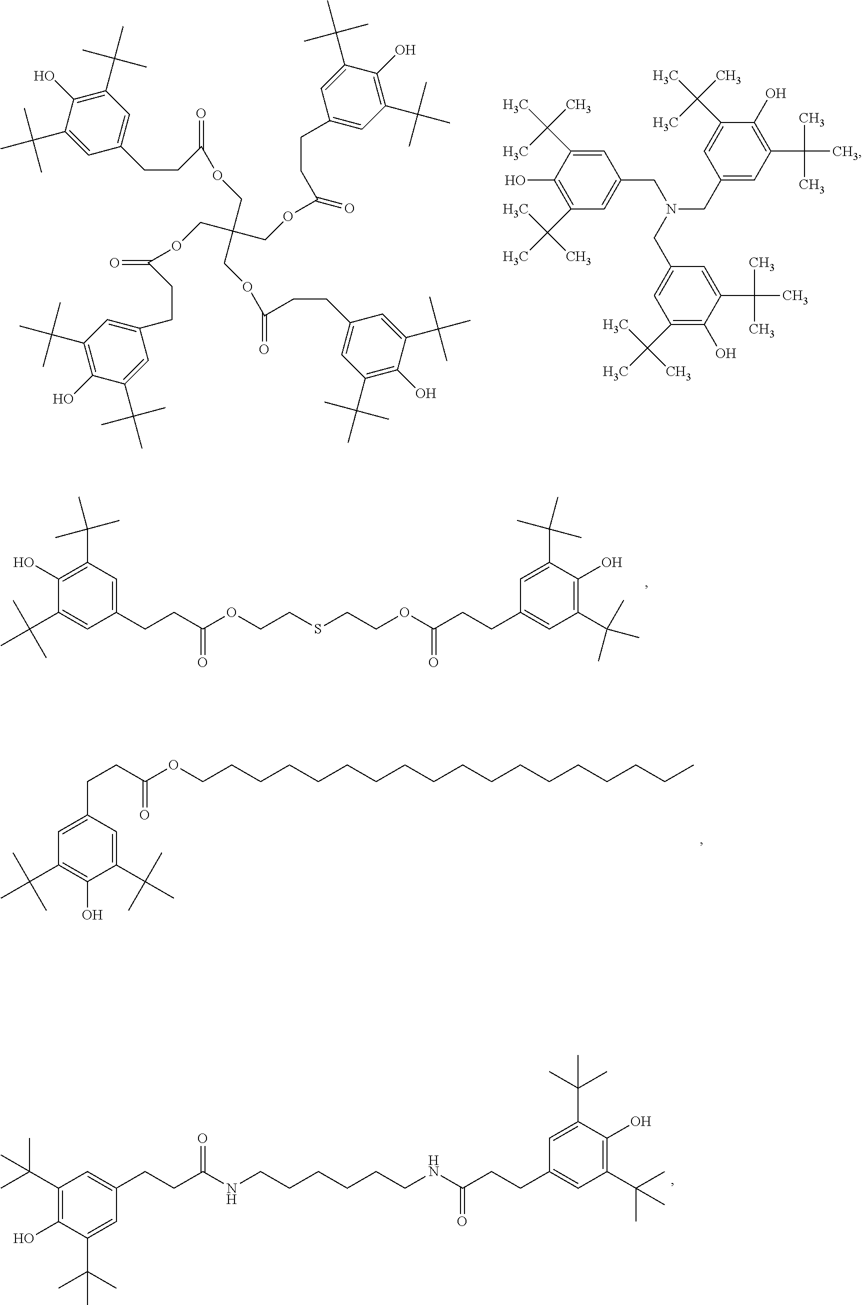

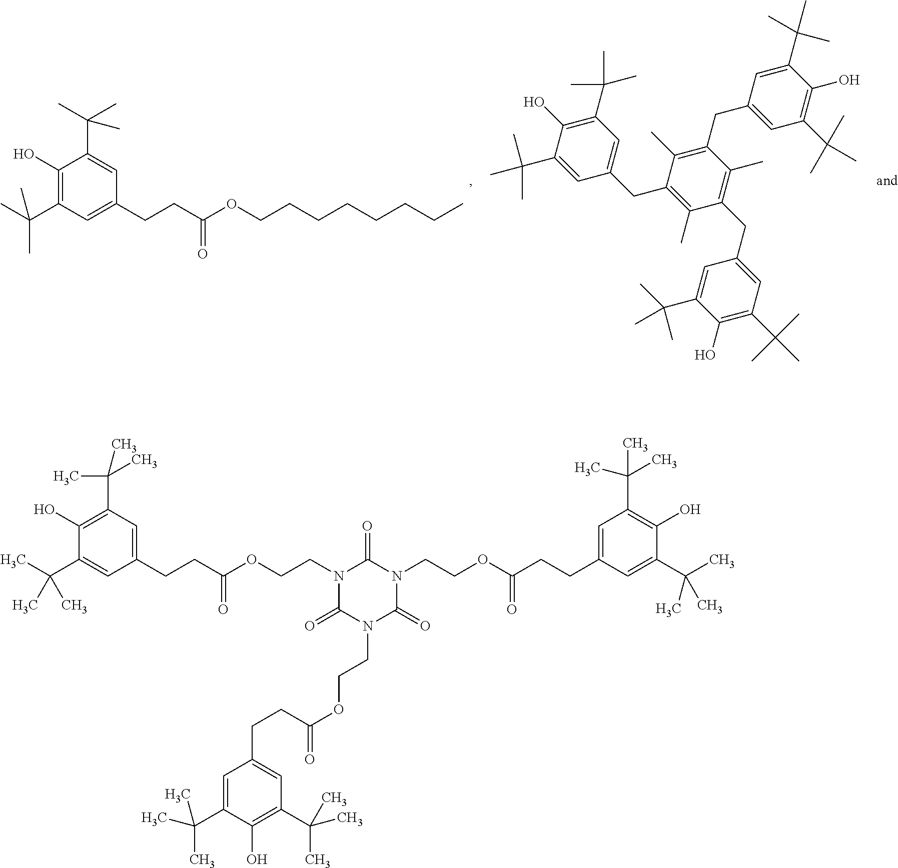

3. The quantum dot composition of any of the above claims wherein the antioxidant comprises one or two hindered phenol groups.

4. The quantum dot composition of claim 3 wherein the antioxidant comprises one hindered phenol group.

5. The quantum dot composition of claim 1 wherein the antioxidant comprises about 0.5 wt % to about 2 wt %, based on the total weight of the quantum dot composition

6. The quantum dot composition of claim 1 wherein the curable resin composition comprises a UV-curable (meth)acrylate resin and thermal curable epoxy-amine resin.

7. The quantum dot composition of claim 1 wherein the curable resin composition comprises a UV-curable thiol-ene composition.

8. The quantum dot composition of claim 1 wherein the quantum dots comprise CdSe/ZnS.

9. A quantum dot article comprising:
(a) a first barrier layer,
(b) a second barrier layer, and
(c) a quantum dot layer between the first barrier layer and the second barrier layer, the quantum dot layer comprising quantum dots dispersed in a matrix comprising a cured curable resin composition, wherein the curable resin composition comprises hindered phenolic antioxidant, wherein the antioxidant comprises about 0.2 wt % to about 5 wt %, based on the total weight of the quantum dot composition.

10. The quantum dot article of claim 9 having a relative lifetime under accelerated aging conditions of at least about 1.5 normalized to the same quantum dot film article without the hindered phenolic antioxidant.

11. The quantum dot article of claim 10 wherein the relative lifetime under accelerated aging conditions is at least about 5 normalized to the same quantum dot film article without the hindered phenolic antioxidant.

12. A quantum dot article comprising
(a) first barrier layer,
(b) a second barrier layer, and
(c) a quantum dot layer between the first barrier layer and the second barrier layer, the quantum dot layer comprising quantum dots dispersed in a matrix comprising a cured curable resin composition that when illuminated by a single pass of 7,000 mW/cm² of 450 nm blue light at 50° C. can maintain a converted power or quantum efficiency greater than 85% its initial value for longer than 80 hours.

13. A quantum dot article comprising
(a) a first barrier layer,
(b) a second barrier layer, and
(c) a quantum dot layer between the first barrier layer and the second barrier layer, the quantum dot layer comprising quantum dots dispersed in a matrix comprising a cured curable resin composition comprising hindered phenolic antioxidant; wherein when illuminated by a single pass of 7,000 mW/cm² of 450 nm blue light at 50° C., the quantum dot article can maintain a converted power or quantum efficiency greater than 85% its initial value for at least 1.5 times longer than the same quantum dot article but containing no hindered phenolic antioxidant.

14. A display device comprising the quantum dot article of claim 1.

15. A display device comprising the quantum dot article of claim 9.

16. A display device comprising the quantum dot article of claim 12.

17. A display device comprising the quantum dot article of claim 13.
